(19) United States
(12) Patent Application Publication
(10) Pub. No.: US 2007/0250364 A1
(43) Pub. Date: Oct. 25, 2007

(54) System and method for one-click docketing

(76) Inventors: Steven W. Lundberg, Edina, MN (US); Pradeep Sinha, Medina, MN (US)

Correspondence Address: SCHWEGMAN, LUNDBERG & WOESSNER/CPA, P.O. BOX 2938, MINNEAPOLIS, MN, 55402, US

(21) Appl. No.: 11/401,164

(22) Filed: Apr. 10, 2006

(51) Int. Cl. G05B 19/418

(52) U.S. Cl. 705/8

(57) ABSTRACT

The present invention includes an apparatus, method and system for one-click docketing of tasks in an internet based patent and trademark application management system. In some embodiments, a client computer is operatively coupled to an application server, which in turn is operatively coupled to a patent information server. These computers are connected via an internet. The configuration of the various computers disclosed herein may vary based upon the distribution the functionality implemented. A user will initiate a one-click (i.e., use a single input signal) docketing process with an input device, such as mouse, or keyboard, wherein an application server will be asked to retrieve case information data from a database. This case information data will, in turn be provided to a patent information server. The patent information server will then use this case information data to retrieve patent information, and provide it to the application server to fill a template.

### CROSS REFERENCE TO RELATED APPLICATIONS

This application is related to the following applications: “INTERNET-BASED PATENT AND TRADEMARK APPLICATION MANAGEMENT SYSTEM”, Steven W. Lundberg, Inventor, Ser. No. 09/872,701, filed Jun. 1, 2001, which claims priority to “INTERNET-BASED PATENT AND TRADEMARK APPLICATION MANAGEMENT SYSTEM”, Ser. No. 60/280,386, filed Mar. 29, 2001; “INTERNET-BASED PATENT AND TRADEMARK APPLICATION MANAGEMENT SYSTEM”, Steven W. Lundberg, Inventor, Ser. No. 10/741,166, filed Dec. 17, 2003, which claims priority to “INTERNET-BASED PATENT AND TRADEMARK APPLICATION MANAGEMENT SYSTEM”, Ser. No. 60/433,935, filed Dec. 17, 2002; and “METHODS, SYSTEMS AND EMAILS TO LINK EMAILS TO MATTERS AND ORGANIZATIONS”, Sinha et al inventors, Ser. No. 10/128,141, filed Apr. 23, 2002 which claims priority to “A SYSTEM FOR SENDING AND RECEIVING ELECTRONIC MESSAGES IN AN ENTERPRISE MANAGEMENT SYSTEM”, Ser. No. 60/285,842, filed Apr. 23, 2001 and “SYSTEM, FUNCTIONAL DATA, AND METHODS FOR ON-LINE COLLABORATING USING MESSAGING, REPORTING, SECURITY, DOCKETING, BILLING, AND DOCUMENT MANAGEMENT”, Ser. No. 60/335,732, filed Oct. 18, 2001. The entire contents of the above cited applications are hereby incorporated herein by reference.

### FIELD OF THE INVENTION

This invention relates to the field of computer implemented systems, apparatus, and methods, that allow for the docketing of various types of correspondence received from, for example, the United States Patent and Trademark Office and the extracting of data from these correspondences and the filing of document templates using this data through a single step.

### LIST OF APPENDICES

An Appendix A containing a list of the approximately 5308 source code files that make up one embodiment of the present invention is attached at the end of this application. These source code files are contain on a CD (i.e., Copy 1) that makes up part of Appendix A. A duplicate copy (i.e., Copy 2) of this CD is also contained in Appendix A. These source code files are incorporated by reference in their entirety into this application.

### COPYRIGHT NOTICE

This patent document contains copyrightable computer software elements including but not limited to source code, flow charts and screen displays. The following notice shall apply to these elements: “Copyright© FoundationIP, LLC”.

### LIMITED WAIVER OF COPYRIGHT

A portion of the disclosure of this patent document contains material to which a claim for copyright is made. The copyright owner has no objection to the facsimile reproduction by anyone of the patent document or the patent disclosure, as it appears in the Patent and Trademark Office patent file or records, but reserves all other copyrights.

### BACKGROUND OF THE INVENTION

Patent agents and attorneys that specialize in patent or trademark prosecution typically draft dozens of patent or trademark applications per year, and are engaged in prosecution of many more. Each of these must be carefully tracked by the attorney or legal assistant, so that important status information such as potential bar dates, deadlines for response to office action amendments and responses, and other data are not overlooked. Management of this data has historically been managed by inclusion of each item on a docket that is tracked on paper docketing calendars, or more recently using commercially available electronic docketing software that serves the same purpose as a calendar. In addition, as more and more files are kept in electronic form it is challenging to provide access to those files in a way that preserves sensitive information from wide dissemination while allowing those with a need to know to view the information.

In certain instances, templates are filed with data relating to, for example, patents and trademarks. These templates can be filled manually, in certain instances, by a user. What is needed in the art is a method, apparatus and system for filling these templates in a more expeditious manner.

### SUMMARY OF THE INVENTION

The present invention provides an apparatus, method and system for one-click docketing of tasks in an internet based patent and trademark application management system. One-clicking docketing within the context of an internet based patent and trademark application management system is a useful functionality that speeds the process of document management. In some embodiments, a client computer is operatively coupled to an application server, which, in turn, is operatively coupled to a patent information server. These computers are connected via an internet. In some embodiments, a user will initiate a one-click docketing process with an input device, such as mouse, wherein an application server will be asked to retrieve case information data from a database. This case information data will, in turn, be provided to a patent information server. The patent information server will then use this case information data to retrieve patent information, and provide it to the application server to fill a template.

In some embodiments, the present invention provides for a method including: initiating a docketing process that is a part of an online patent and trademark application management system, retrieving case information data from a database, providing the case information data to a patent information server, retrieving patent information data based upon the case information data from the patent information server, and the associating of the patent information data with a template. In some embodiments, the present invention provides for an additional method wherein if there is a correct associating of the patent information with a template, this results in a filled template being displayed to a user. In some embodiments, the method of the present invention further includes implementing functionality wherein if there is an incorrect association of the patent formation with a template, then an error prompt displayed to a user. In some embodiments, the method of the present invention includes uploading the filled template to a client computer. In some embodiments, the present invention provides for the method implemented wherein the case information includes, for example: attorney docket information, a control number, a PCT number, a patent number, a publication number, an application number, and/or a customer number. In some embodiments, the method of the present invention includes patent information data such as, for example: office actions, notices of allowance, and notices of issuances.

In some embodiments, the present invention provides for a computer readable medium having instructions contained thereon for causing a computer to execute a method including: initiating a docketing process that is a part of a online patent and trademark application management system, retrieving case information data from a database, providing the case information data to a patent information server, retrieving patent information data based upon the case information data from the patent information server, and associating the patent information data with a template. In some embodiments, the present invention provides for a computer readable medium having instructions stored thereon wherein a correct association of the patent information with a template results in a filled template displayed to a user. In some embodiments, the present invention provides for a computer readable medium having instructions stored thereon, wherein an incorrect association of the patent formation with a template results in an error prompt being displayed to a user. In some embodiments, the present invention provides for a computer readable medium having instructions stored thereon, further including uploading the filled template to a client computer. In some embodiments, the present invention provides for a computer readable medium having instructions stored thereon wherein the case information includes, for example: attorney docket information, a control number, a PCT number, a patent number, a publication number, an application number, and a customer number are implemented. In some embodiments, the present invention provides for a computer readable medium having instructions stored thereon, wherein the patent information includes, for example: office actions, notices of allowance, and notices of issuances are implemented.

In some embodiments, the present invention provides for a system including, a client machine operatively coupled to an application server via an internet in a client-server configuration for initiating a one-click docketing process that is a part of a online patent and trademark application management system, and a patent information server operatively coupled to an application server via an internet, a database server operatively coupled to the application server, and a second data database server operatively coupled to the patent information server. In some embodiments, the present invention provides for a system wherein the application server retrieves case information data from the database server. In some embodiments, the present invention provides for a system wherein the patent information server retrieves patent information data form the second data base server. In some embodiments, the present invention provides for a system wherein the application server associates the patent information data with a template. In some embodiments, the present invention provides for a system wherein a correct association of the patent information with a template by the application server results in a filled template displayed to a user. In some embodiments, the present invention provides for a system wherein an incorrect association by the application server of the patent information with a template results in an error prompt being displayed to a user. In some embodiments, the present invention provides for a system wherein the client machine uploads the filled template via an internet to the client computer. In some embodiments, the present invention provides for a system further including an input device operatively coupled to the client machine, the input device including: a mouse, a keyboard, and a touch screen.

### BRIEF DESCRIPTION OF THE DRAWINGS

FIG. 1 network diagram 100 disclosing the operative coupling of a client machine 101, a web server 103, various application servers 104, and a database server 105.

FIG. 2 is a schema 200 depicting various software modules operatively coupled to one another. These modules include a browser application 201 residing on a client machine 101 operatively coupled to an application server 205, wherein the application server has a server page module 203 operatively coupled to a one-click docketing module 202. This application server 205 is operatively coupled to a database server 105, upon which resides a database application 204. The database application 204 is operatively coupled to the server pages module 203 and one-click docketing module 202.

FIG. 3 is a network diagram 300 disclosing the operative coupling of a client machine 101, application server 205, and patent information server 303 via internet 102, and illustrates how requests 301, 302 and data 304 are transmitted between the various client computer 101 and server computers 205 and 303.

FIG. 4 is a network diagram 400 disclosing the operative coupling of the client machine 101 and the application server 205 and the transmission, uploading of data 401 to the client machine 101.

FIG. 5 is a flow chart 500 depicting the logic of the one-click module.

### DESCRIPTION OF EMBODIMENTS

In the following detailed description of the preferred embodiments, reference is made to the accompanying drawings that form a part hereof, and in which are shown by way of illustration specific embodiments in which the invention may be practiced. It is understood that other embodiments may be utilized and structural changes may be made without departing from the scope of the present invention.

The leading digit(s) of reference numbers appearing in the Figures generally corresponds to the Figure number in which that component is first introduced, such that the same reference number is used throughout to refer to an identical component which appears in multiple Figures. Signals and connections may be referred to by the same reference number or label, and the actual meaning will be clear from its use in the context of the description.

### Overview of an Internet-Based Patent and Trademark Application Management System

In one embodiment of the invention, a web-based service provides a legal entity or a client or other affiliate of a legal entity access to data management functions to facilitate legal proceedings. A law firm may utilize the web-based system to track data for a client, such as patent and trademark status, docketing, documentation, and billing.

In some embodiments, a client may be provided access to the web-based system, and when the client accesses the system is offered account setup functions which when selected enable the client to utilize the system to perform various functions separate from and optionally visible to the law firm. For example, an invention disclosure management module may be a part of the web-based service that is utilized by the client, but invention disclosures entered into and managed by the system will not be visible to the law firm until they are released to the law firm's attention. The client may therefore use the web-based system to store invention disclosures and use them for evaluation, budgeting, awarding of inventor stipends, or for other functions that are not initially or may never be visible to the law firm, as well as to record disclosure information that is selectively or entirely released to the attention of the law firm or to any other law firm.

In some embodiments, invention disclosure management in further embodiments includes a function for receiving invention disclosures and for time-stamping receipt of received disclosures for date of invention record verification purposes. Also, the invention disclosure module may comprise a facility so that reviewers of an invention disclosure may electronically witness and sign an invention disclosure, such that the signature of the signing witnesses is further date-stamped with data indicating the date of electronic signing.

In at least one embodiment, the invention tracking module in some embodiments is further operable to track potential bar dates relating to national and international filing, based on data entered relating to an offer for sale, public use, publication, or other activities relating to the invention. The module provides notice at various dates to the client of nearing potential bar dates, alerting the client to the potential bar date and the action that must be taken to ensure rights are not lost.

In some embodiments, the functions available to the client also include in some embodiments calendar or date tracking functions relating to various activities performed in the course of IP management, such as invention disclosure meetings, attorney meetings, technical review board meetings, etc., and if applicable further track decisions or results of these meetings such as whether to pursue a patent application relating to a specific invention disclosure.

In some embodiments, one module of the web-based system usable for client data management, in one embodiment, comprises a data registry of various intellectual property held, such as records relating to trade secret identification and retention, a record of various trademarks and their uses and relevant registration or other legal information, and a patent portfolio log indicating issued patents and their various characteristics such as keyword and subject classification data such that a client may readily view and understand a record of his intellectual property holdings. In a further embodiment of the invention, the web-based system comprises a module operable to search the data relating to these various intellectual property assets, and to produce an intellectual property report or audit.

In some embodiments, the client system will in some embodiments include a document system enabling creation or merging of various documents relating to intellectual property matters. License agreements, assignments, non-disclosure agreements, and other such legal documents are examples of documents that may be useful to clients and are included in the various embodiments of the invention.

In some embodiments, the client's account data can be readily exchanged with the law firm via the web-management system in some embodiments, such that invention disclosure and potential bar date information relating to a case can be made available to the law firm once the decision to pursue a patent for a particular invention disclosure is made. In further embodiments, the web-based system provides issued patent or other reference search capability in various embodiments to the law firm and to the client for performing and documenting an electronic patentability search and review, so that results of a patentability search relating to an invention disclosure can be stored, and relevant documents recorded for preparation of an Information Disclosure Statement.

Further, in one embodiment, the law firm and the client are capable of exchanging other data via the web-based system, such as submission of a trademark, copyright, or trade secret matter for various purposes, as well as capability to track and coordinate data relating to other matters such as opinion-related issues and work. In one embodiment of the invention, these various intellectual property matters are identified to the client and to the law firm by a matter or activity identifier which need not be the same for both client and law firm, but which identify the same matter and enable identification and specification of data relating to the various matters in which the law firm and client are involved. In addition to matter identifier-based viewing of data, the web-based module in various embodiments comprises activity-based views in which an entity may view the various activities requiring attention for his various matters, may view all matters which have a certain activity pending, or may view another activity-based view of the intellectual property matters under management.

In some embodiments of the invention, the web-based systems used by the client and the law firm are the same computerized system, while in other embodiments they are separate computerized systems but are operable to exchange data as appropriate for proper operation of the invention as described in the above various examples. In some embodiments where the same system is used, various forms of encryption are used to ensure the confidentiality of data as it travels over the Internet or other network. In embodiments where a separate computerized system is utilized by the client, the client may install and configure his own computerized system to host a local web-based system consistent with the present invention such that the client's confidential information such as trade secret information and invention disclosures not released to external entities are held within systems under the client's control. Such systems will be able to exchange data with other computerized data management systems under the client's direction, and so provide the various functions discussed in the example embodiments of the invention presented herein.

In some embodiments, the present invention can provide systems and methods for management of intellectual property information, legal information, and/or patent and trademark applications. Various embodiments are described herein with reference to the Figures.

In some embodiments, the invention comprises in one embodiment a system for managing patent application data via the Internet, and comprises matter, task, and security modules. The matter module is operable to manage data such as docketing data relating to patent matters, the tasks module is operable to manage tasks related to each matter managed by the matter module, and the security module is operable to restrict access to task and matter data management to selected system users. The system is implemented in some embodiments as a World Wide Web site on the Internet, which in further embodiments comprises various components such as an application server, a Java server, and a database.

### A Three-Tier Architecture

In some embodiments, the present invention can be thought of as a distributed or non-distributed software application designed under a three-tier software architecture paradigm, whereby the various modules of computer code that make up the present invention can be categorized as belonging to one or more of these three tiers. A three-tier software architecture is well known in the art. (See Applying UML and Patterns: An Introduction to Object-Oriented Analysis and Design and the Unified Process 2nd Edition, by Craig Larman, Prentice Hall, 2002.) The first tier is an Interface level that is relatively free of application processing. The second tier is a Logic level that performs processing in the form of logical/mathematical manipulations (Logical Manipulations) of data inputted, in some embodiments, through the Interface level, and communicates the results of these manipulations with the Interface and/or backend or Storage level. In some embodiments, these Logical Manipulations relate to certain business rules or tasks that govern the application as a whole. In some embodiments, these Logical Manipulations and associated business rules include: the purging of messages in a legal information system, the auto-filing of a result in an IP management system, the obtaining and disseminating of secured on-line data, generating work flow templates, regulating the export control of technical documents, the bulk downloading of documents, billing, creating and managing matter clusters, configuring certain activities, managing independent docket systems, prior art cross citations, and exchanging public and private messages, just to name a few. The Storage level is a persistent, or, in some embodiments, a non-persistent storage medium. In some embodiments, one or more of these tiers is collapsed into another, resulting in a two-tier architecture, or one-tier architecture. For example, the Interface and Logic levels may be consolidated, or the Logic and Storage levels may be consolidated, as in the case of an application with an embedded database. This three-tier architecture may be implemented using one technology or, as will be discussed below, a variety of technologies. These technologies may include one or more object-oriented programming languages such as, for example, Java™, C++, Delphi™, C#™, or the like. Additional structured programming languages such as, for example, C may also be used. Moreover, scripting languages such as, for example, Perl, Python, PHP, JavaScript or VBScript may also be used. This three-tier architecture, and the technologies through which it is implemented, in some embodiments, can be implemented in two or more computers organized in a server-client relationship, as is well known in the art, such that an Interface level resides on a client computer, whereas the Logic level resides on the application server (see below) and the Storage level resides on a database server (see below). (See Computer Networking: A Top-Down Approach Featuring the Internet 2nd Edition, James F. Kurose and Keith W. Ross, Addison-Wesley, 2003.) Put another way, in some embodiments, these three levels may be distributed between more than one computer.

### An Interface Level

In some embodiments, the present invention is implemented using a client-based browser application. Some well-known client-based browser applications include the Netscape Browsers™, Internet Explorer™, Mozilla Firefox™, or Opera™, just to name a few. Common to these browser applications, is the ability to utilize a hyper-text transfer protocol (HTTP) or secured hyper-text transfer protocol (HTTPS) to get, upload (i.e, PUT) or delete web pages and interpret these web pages which are written in a hyper-text markup language (HTML) and/or an extensible-markup language (XML). HTTP and HTTPS are well known in the art, as are HTML and XML. (See id. XML for the World Wide Web, by Elizabeth Castro, Peachpit Press, 2000; Data on the Web: From Relations to Semistructured Data and XML 1st Edition, by Serge Abiteboul, Peter Buneman, & Dan Suciu, Morgan Kaufmann, 1999.) HTTP and HTTPS are, in some embodiments, used in conjunction with a TCP/IP protocol as described in the OSI model, or the TCP Protocol Stack model, both of which are well known in the art. (See Computer Networking: A Top-Down Approach Featuring the Internet 2nd Edition, James F. Kurose and Keith W. Ross, 2003.) The practical purpose of the client-based browser application is to enable a user to interact with the application through the display of plain text, and/or interactive, dynamic functionality in the form of buttons, text boxes, scroll down bars or other objects contained on one or more web pages constructed using the aforementioned HTML and/or XML.

Web pages are typically static or dynamic in nature. Those that are static typically display text as one would see it on a printed, physical page. Dynamic web pages, however, are interactive and allow for a user to input data, query data, and/or modify data just to name a few of the functionalities associated with dynamic web pages. The dynamic nature of web pages, in some embodiments, is a product of the use of other technologies in combination with HTML and/or XML.

In some embodiments, Java Server Pages (JSP™), or Active Server Pages (ASP™ or ASP.NET™) (collectively server pages) are used to provide a user with dynamic web pages or content via their web browser. In some embodiments, additional technology in the form of an additional program (i.e, a routine) written in another programming language is embedded into the HTML and/or XML code, allowing for the web pages to become dynamic. Some of these additional technologies include, for example, embedded routines written in the Java™ programming language, the Java Script language, or the Visual Basic™ programming language, just to name a few. In some embodiments, these embedded routines are used to execute the aforementioned HTTP, HTTPS requests (i.e., GET, PUT, and DELETE) for web pages. Various types of programming structures such as branches, loops and other types of logic structures are used in such routines. These routines may, in some embodiments, allow a user to login, and request content or upload content.

In some embodiments, for example, a GUI is used and is implemented via a Java Servlet, Applet, or VBScript form, just to name a few. As will be discussed below, web pages containing GUIs are, in some embodiments, stored at the Logical level, but executed at the Interface level via a web browser. These server pages contain objects such as text boxes, buttons, scroll-down bar, just to name few. These objects, and the routines governing them, allow a user to retrieve, input, or delete content, just to name a few of the functions. For example, in some embodiments a user will be prompted with a login page requesting username and password information to be entered into two or more text boxes. Once the data entered into the text boxes is verified, a second, new web page will be requested, interpreted and displayed in the browser application. The verification of the login information would take place at the Logic level outlined below.

### A Logic Level

In some embodiments, the above-described Servlets, Applets and/or VBScript forms are stored as a JSP™, or ASP™ on one or more remote server computers connected to the client computer via an internet. These remote servers can, in some embodiments, be a web server and/or application server. In some embodiments, web servers running JSP™ can include the Apache™/Apache™ Tomcat web server. In some embodiments, web servers running ASP™ can include Microsoft Windows Web Server 2003™. In some embodiments, application servers running JSP™ can include an Orion Application Server, or J2EE™ Application Server, just to name a few. In some embodiments, application servers running ASP™ can include Windows Server 2003™.

In some embodiments, the Logic level is governed by a scripting language that controls how and when certain web pages or pieces of content are provided to, or made accessible to a particular user. This scripting language can be in the form of Java™, Perl, Python or some other general purpose scripting language. For example, once the logic of a JSP™ determines that a particular object (e.g., a text box) on web page has been executed (e.g., a username and password is entered and sent), the data from this text box is inputted, sent to the web or application server. In some embodiments, it is the logic of a routine written in a scripting language that determines what will be sent to the user upon the successful verification of the username and password. In some embodiments, it is the routine written in a scripting language that determines whether, for example, the username and password are valid. In some embodiments, the routine written in a scripting language will serve to retrieve data from a storage, data structure or database level. In some embodiments, the Storage level will be a run by a separate database application, while in other embodiments a database embedded with a Logical level will be implemented.

### A Storage Level

In some embodiments, a Storage level is implemented whereby tables of data are created, and data is inserted into, or selected from, these tables using a structured query language (SQL) or some other database-related language known in the art. (See The Fundamentals of Database Systems 3rd Edition, by Remez Elmasri & Shamkant B. Navathe, Addison-Wesley, 2000.) These tables of data can be managed using a database applications such as, for example, MySQL™, SQL Server™, or Oracle 9i™ or 10g™, just to name a few. These tables, in some embodiments, are organized into a relational-database schema (RDS) or object-relational-database schema (ORDS), as is known in the art. (See id.) In some embodiments, these schemas can be normalized using certain normalization algorithms so as to avoid abnormalities such as non-additive joins and other problems. In some embodiments, these normalization algorithms include Boyce-Codd Normal Form or some other normalization, optimization algorithm known in the art. (See id.) For example, in some embodiments, username and associated password information are stored together such that the scripting routine can compare the inputted, received username and password information to that data stored in the database.

### A General Network Diagram

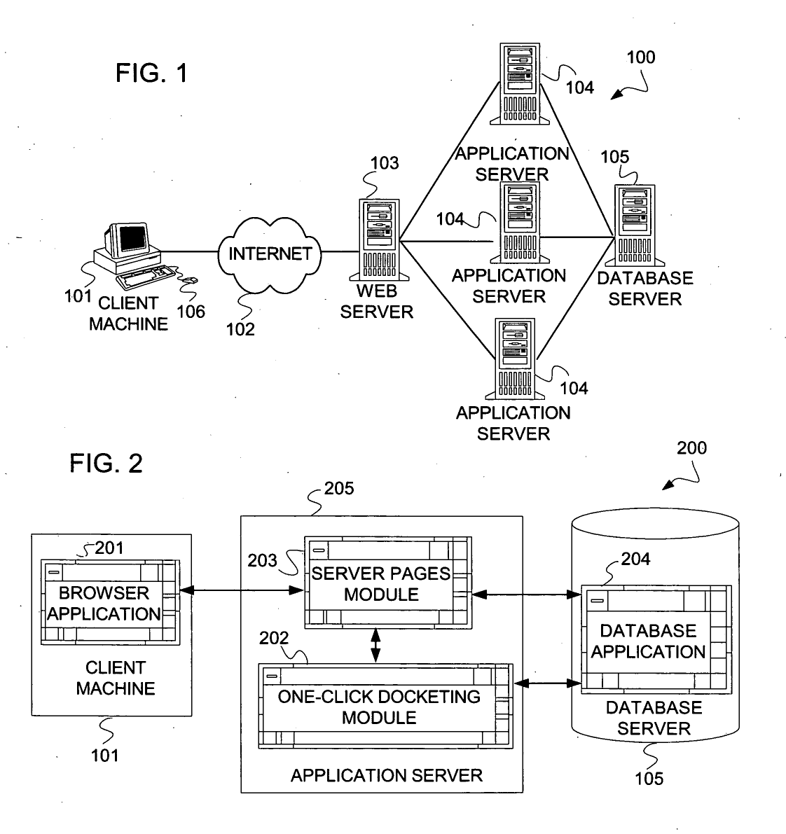

An implementation of the above outlined three-tier architecture is reflecting in the network diagram 100 disclosed in FIG. 1. That, in some embodiments, the various functionalities of the three-tier architecture can be divided up between (i.e., distributed) various client and server computers, configured in a server-client relationship. In still other embodiments, as described below, two or more of these tiers or levels may be combined together and/or run on the same computer. In some embodiments, a client machine 101 with a mouse 106 is operatively coupled to a web server 103 via an internet 102. Using the client computer 101 and the mouse 106, data can be requested from the web server 103. Indeed, in some embodiments, this data can be requested with one simple click of a mouse. This data, can, in some embodiments, take the form of various server pages. In some embodiments, this web server 103 will request these server application pages from one or more application servers 104 operative coupled to the web server 103. In some embodiments, this web server 103 is operatively coupled to the one or more application servers 104 via an internet (described herein but not referenced). In some embodiments, these various application servers 104 will, in turn, request data from a database server 105 operatively coupled to the one or more application servers 104. In some embodiments, this database server 105 is operatively coupled to the one or more application servers 104 via an internet (described herein but not referenced). In terms of the above outlined three-tier architecture, the client machine 101 and mouse 106 provide the platform for the above described Interface level, the web server 103 and one or more application servers 104 provide the platform for a logical level, and the database server 105 provides a platform for a Storage level.

### An Software Architectural Diagram Reflecting the Functionality of the Network Diagram

In some embodiments, the functionalities of each of these various servers (e.g., Nos. 103 and 104) can be implemented on one server. For example, in FIG. 2 a schema 200 depicts one embodiment where the functionality of the web server 103 and the one or more application servers 104 are implemented on a single application server 205. The functionality of the web server is reflected in a server pages module 203, whereas the functionality of the one or more application servers 104 is reflected in the functionality of the one-click docketing module 202 (collectively a Logic level). As with FIG. 1, the client machine 101 and its associated browser application 201 (i.e., the Interface level), and the database server 105 and its associated database application 204 (i.e., the Storage level) remain separate.

### A Specific Network Diagram Reflecting One-Click Docketing

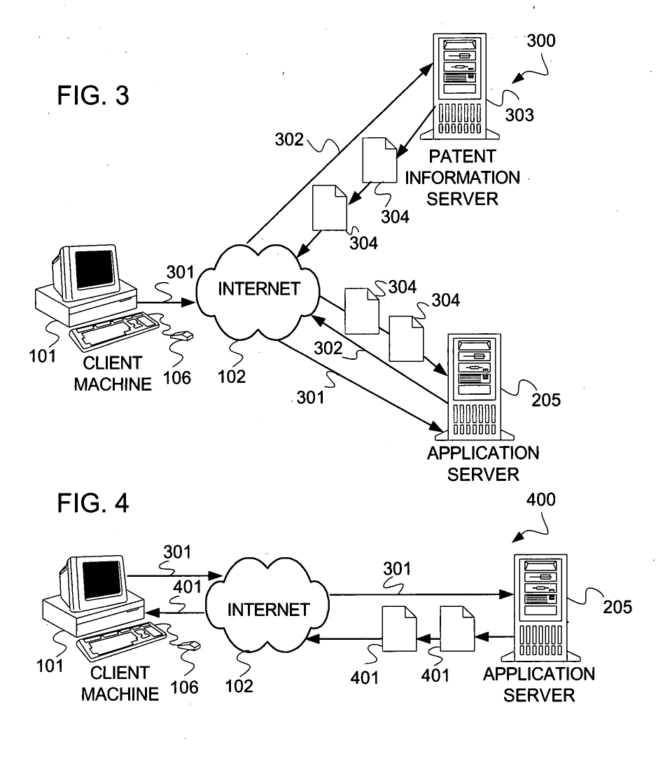

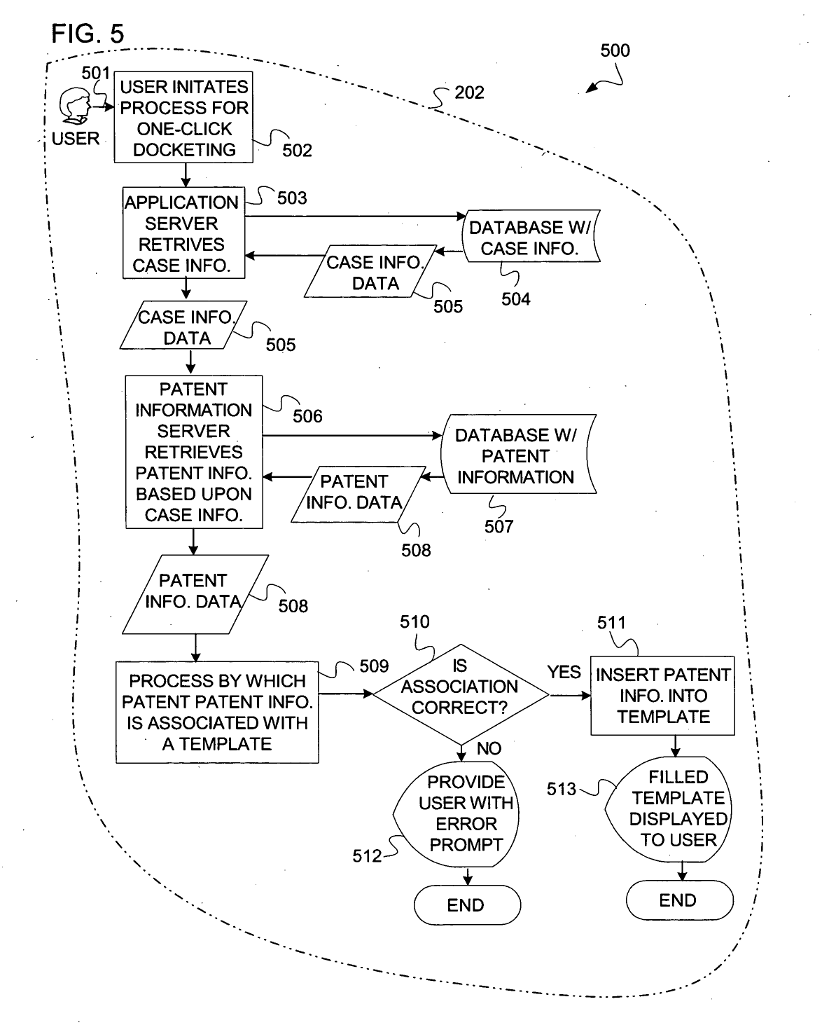

In some embodiments, a user using a client machine 101 utilizing a mouse 106 requests that patent data be docketed, and templates relating to this patent data be filed with the data. FIG. 3 is a network diagram 300 depicting a client machine 101 operatively coupled to an application server 205 via an internet 102. In some embodiments, a data request 301 is sent to the application server 205 via an internet 102 for data relating to particular docketed matter. This data request 301 is then processed by the application server 205, and sent onto a patent information server 303 as a data request 302 via an internet 102. Once the data request 302 is sent onto the patent information server 303, the patent information server 303 returns the requested data 304 via the internet 102 to the application server 205. In some embodiments, the patent information server 303 runs a patent application information retrieval (“PAIR”) software application as is known in the art. Once this requested data 304 is received by the application server 205, it can be stored, manipulated (see description of FIG. 5 below), and/or uploaded to a client machine 101 (see FIG. 4 below.).

FIG. 4 is a network diagram 400 of the uploading of data from an application server 205 to a client machine 101. In one embodiment, a data request 301 is sent via an internet 102 to the application server 205. Once the steps outlined in FIG. 3 are completed, display and/or upload data 401 (i.e., “data 401”) may be sent via an internet 102 to a client machine 101.

### A One-Click Docketing Module

In some embodiments, a one-click docketing module written in one of the above described object oriented programming languages is implemented. In one embodiment, this module can be implemented using component oriented or object-oriented programming techniques such as, a Visual Component Library (“VCL”), Component Library for Cross Platform (“CLX”), Java Beans (“JB”), Java Enterprise Beans (“EJB”), or Component Object Model (COM) just to name a few. Typically these modules are linked to another program via various APIs and then compiled into one complete server and/or client application. The process for using modules in the building of client and server applications is well known in the art. (See Component Based Software Engineering: Putting the Pieces Together, by George T. Heineman and William T. Council, Addison-Wesley, 2001; Delphi Component Design, by Danny Thorpe, Addison-Wesley, 1996.). In the present invention, a one-click docketing module is written using one of the above described techniques in conjunction with an object oriented programming language and is compiled together with an internet based patent and trademark application management system, thus providing additional functionality to this system.

### A Logic Level Related to One-Click Docketing

In some embodiments, as described above, a Logical level follows certain business rules, which are, in turn, implemented via software. In some embodiments, this logical level is implemented using the above outlined technology relating to a Logic level. (See Logic level outlined above.) These technologies include, in some embodiments, an Orion Application Server™, or J2EE™ server just to name a few. As described above, in some embodiments, the logic underlying this level can be written in an object-oriented programming language as is known in the art, while individual libraries that make up this application may be called using a scripting language as is described above.

FIG. 5 is a flow chart 500 of the logical level for a one-click docketing module 202 illustrating, among others things, how requested data 304 may be manipulated as data 401 and provided to a user 501. In some embodiments, a user 501 initiates a process 502 for one-click docketing by pressing a button (i.e., executing one-click) on a mouse 106. In some embodiments, other means of executing this process 502 such as, for example, pressing a single key on a keyboard may be applied. The manner of executing this process 502 is only limited by the types of data input available to a client machine 101, wherein a single input signal can be used to initiate a docketing process Once initiated, through the network described above in FIG. 3, an application server process 503 retrieves data 505 from a database 504 containing case or matter information. In some embodiments, this data 505 includes, for example, attorney docket information, a control number, a PCT number, a patent number, a publication number, an application number, and/or a customer number, just to name a few. This data 505 is provided to a process 506 contained on a patent information sever 303, wherein the process 506 retrieves patent information data 508 from a database 507 that contains patent information. In some embodiments, this patent information data 508 includes, for example, information relating to office actions, reexams, notices of allowance, and notices of issuances, and other forms of administrative correspondence. In one embodiment, the present invention retrieves this patent information data 508 from a PAIR software application residing on a patent information server 303. In some embodiments, this patent information data 508 is scraped from the database 507, wherein relevant information is extracted from the database 507 in its native form, or as presented in an HTML, XML, or some other format.

After this patent information data 508 is retrieved by the application server 205, a process 509 is executed wherein the patent information data 508 is associated with a template. In some embodiments, these templates relate to, for example, responses to office actions, responses to notices of allowance, responses to notices of issuance, and other types of responses to various administrative correspondence. In some embodiments, if the association is correct (i.e., “true”) and the correct template has been associated with the correct patent information data 508, then the patent information data 508 will be inserted into a template via a process 511. If, however the association is incorrect (i.e., “false”) and incorrect patent information data 508 has been associated with the wrong template, then the data will not be inserted into the template. Branch 510 controls the logic behind whether the data association is correct. If the data association is correct, then the user 501 will receive a prompt 513 and a filled template will be displayed to the user 501. If, however, the association is incorrect, the user will receive an error prompt 512.

In some embodiments, if the association is correct, the user will have the option to upload the filled template to the client machine 101. This upload is depicted in FIG. 4 above. The logic for such an upload, is known in the art, and at least on embodiment is provided by the source code appendix contained herein, or other application incorporated by reference herein.

In some embodiments, the present invention provides for a method including: initiating a docketing process that is a part of an online patent and trademark application management system, retrieving case information data from a database, providing the case information data to a patent information server, retrieving patent information data based upon the case information data from the patent information server, and the associating of the patent information data with a template. In some embodiments, the present invention provides for an additional method to be implemented wherein if there is a correct associating of the patent information data with a template that results in a filled template being displayed to a user. In some embodiments, the present invention provides for a method that further includes implementing functionality wherein if there is an incorrect association of the patent formation with a template, then an error prompt is displayed to a user. In some embodiments, the present invention provides for the method further including uploading the filled template to a client computer. In some embodiments, the present invention provides for a method implemented wherein the case information includes, for example: attorney docket information, a control number, a PCT number, a patent number, a publication number, an application number, and/or a customer number. In some embodiments, the present invention provides for a method implemented wherein the patent information includes, for example: office actions, notices of allowance, and notices of issuances.

In some embodiments, the present invention provides for a computer readable medium having instructions contained thereon for causing a computer to execute a method including: initiating a docketing process that is a part of a online patent and trademark application management system, retrieving case information data from a database, providing the case information data to a patent information server, retrieving patent information data based upon the case information data from the patent information server, and associating the patent information data with a template. In some embodiments, the present invention provides for a computer readable medium having instructions stored thereon which are implemented wherein a correct association of the patent information with a template results in a filled template being displayed to a user. In some embodiments, the present invention provides for the computer readable medium having instructions stored thereon, wherein an incorrect association of the patent formation with a template results in an error prompt being displayed to a user. In some embodiments, the present invention provides for a computer readable medium having instructions stored thereon including a method including uploading the filled template to a client computer. In some embodiments, the present invention provides for a computer readable medium having instructions stored thereon which are implemented wherein the case information data includes, for example: attorney docket information, a control number, a PCT number, a patent number, a publication number, an application number, and a customer number. In some embodiments, the present invention provides for a computer readable medium having instructions stored thereon which are implemented, and wherein the patent information data includes, for example: office actions, notices of allowance, and notices of issuances.

In some embodiments, the present invention provides for a system including, a client machine operatively coupled to an application server via an internet in a client-server configuration for initiating a one-click docketing process that is a part of a online patent and trademark application management system, and a patent information server operatively coupled to an application server via an internet, a database server operatively coupled to the application server, and a second data database server operatively coupled to the patent information server. In some embodiments, the present invention provides for a system wherein the application server retrieves case information data from the database server. In some embodiments, the present invention provides for a system wherein the patent information server retrieves patent information data form the second data base server. In some embodiments, the present invention provides for a system wherein the application server associates the patent information data with a template. In some embodiments, the present invention provides for a system wherein a correct association of the patent information with a template by the application server results in a filled template displayed to a user. In some embodiments, the present invention provides for a system wherein an incorrect association by the application server of the patent information with a template results in an error prompt being displayed to a user. In some embodiments, the present invention provides a system wherein the client machine uploads the filled template via an internet to the client computer. In some embodiments, the present invention provides for a system further including an input device operatively coupled to the client machine, the input device including: a mouse, a keyboard, and a touch screen.

It is to be understood that the above description is intended to be illustrative, and not restrictive. Although numerous characteristics and advantages of various embodiments as described herein have been set forth in the foregoing description, together with details of the structure and function of various embodiments, many other embodiments and changes to details will be apparent to those of skill in the art upon reviewing the above description. The scope of the invention should be, therefore, determined with reference to the appended claims, along with the full scope of equivalents to which such claims are entitled. In the appended claims, the terms “including” and “in which” are used as the plain-English equivalents of the respective terms “comprising” and “wherein,” respectively. Moreover, the terms “first,” “second,” and “third,” etc., are used merely as labels, and are not intended to impose numerical requirements on their objects.

What is claimed is:

1. A method comprising:
initiating a docketing process with a single input signal wherein the docketing process is a part of an online patent and trademark application management system;
retrieving case information data from a database;
providing the case information data to a patent information server;
retrieving patent information data based upon the case information data from the patent information server; and
associating the patent information data with a template.

2. The method claim 1, wherein correctly associating the patent information data with a template results in a filled template being displayed to a user.

3. The method of claim 1, wherein incorrect associating the patent formation data with a template results in an error prompt being displayed to a user.

4. The method of claim 2, further comprising uploading the filled template to a client computer.

5. The method of claim 1, wherein the case information data includes:
attorney docket information;
a control number;
a PCT number;
a patent number;
a publication number;
an application number; and
a customer number.

6. The method of claim 1, wherein the patent information data includes:
office actions;
notices of allowance; and
notices of issuances.

7. A computer readable medium having instructions stored thereon for causing a computer to execute a method comprising:
initiating a docketing process with a single input signal wherein the docketing process is a part of an online patent and trademark application management system;
retrieving case information data from a database;
providing the case information data to a patent information server;
retrieving patent information data based upon the case information data from the patent information server; and
associating the patent information data with a template.

8. The computer readable medium having instructions stored thereon for causing a computer to execute the method of claim 7, wherein correctly associating the patent information data with a template results in a filled template being displayed to a user.

9. The computer readable medium having instructions stored thereon for causing a computer to execute the method of 8, wherein an incorrectly associating the patent formation data with a template results in an error prompt being displayed to a user.

10. The computer readable medium having instructions stored thereon for causing a computer to execute the method of claim 7, further comprising uploading the filled template to a client computer.

11. The computer readable medium having instructions stored thereon for causing a computer to execute the method of claim 7, wherein the case information data includes:
attorney docket information;
a control number;
a PCT number;
a patent number;
a publication number;
an application number; and
a customer number.

12. The computer readable medium having instructions stored thereon for causing a computer to execute the method of 7, wherein the patent information data includes:
office actions;
notices of allowance; and
notices of issuances.

13. A system comprising:
a client machine operatively coupled to an application server via an internet in a client-server configuration for initiating a one-click docketing process that is a part of a online patent and trademark application management system; and
a patent information server operatively coupled to an application server via an internet;
a database server operatively coupled to the application server; and
a second data database server operatively coupled to the patent information server.

14. The system of claim 13, wherein the application server retrieves case information data from the database server.

15. The system of claim 13, wherein the patent information server retrieves patent information data form the second data base server.

16. The system of claim 15, wherein the application server associates the patent information data with a template.

17. The system of claim 16, wherein a correct association of the patent information data with a template by the application server results in a filled template displayed to a user.

18. The system of claim 16, wherein an incorrect association by the application server of the patent information data with a template results in an error prompt being displayed to a user.

19. The system of claim 17, wherein the client machine uploads the filled template via an internet to the client computer.

20. The system of claim 13, further comprising an input device operatively coupled to the client machine, the input device including:
a mouse;
a keyboard; and
a touch screen.
